(19) United States
(12) Patent Application Publication
(10) Pub. No.: US 2004/0142185 A1
(43) Pub. Date: Jul. 22, 2004

(54) Anti-reflection spectacle lens and its production method

(75) Inventor: Hidenori Takushima, Tochigi-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/700,560

(22) Filed: Nov. 5, 2003

(30) Foreign Application Priority Data
Nov. 6, 2002 (JP) 2002-322506

(51) Int. Cl. B32B 27/00

(52) U.S. Cl. 428/447; 428/421

(57) ABSTRACT

An anti-reflection spectacle lens has an anti-reflection film composed of a plurality of layers formed on at least one surface of a lens substrate or other one or more layers formed on said lens substrate, the anti-reflection film comprising an outermost layer made of silicon oxide, on which a water- and oil-repellent layer is formed by vacuum deposition. The spectacle lens is excellent in water and oil repellency, and aqueous stains and oily stains attached to the spectacle lens can easily be wiped off. The use of a pellet impregnated with a hydrophobic, reactive organic compound in a vacuum deposition chamber contributes to the reduction of a production cost.

### FIELD OF THE INVENTION

The present invention relates to an anti-reflection spectacle lens having a water- and oil-repellent layer, and a method for producing such an anti-reflection spectacle lens.

### BACKGROUND OF THE INVENTION

Optical products such as spectacle lenses with strong reflection provide clear reflected image such as ghost and flare, failing to give clear visibility. To prevent such reflection, anti-reflection films are generally formed on the spectacle lenses.

The anti-reflection films generally have single- or multi-layer structures, which are formed on the spectacle lenses by physical treatments. The anti-reflection films are usually provided with surface layers composed of silicon oxide or magnesium fluoride having high hardness and low refractive indexes. However, if the layers of silicon oxide or magnesium fluoride were washed with water and left to stand for drying without sufficiently wiping water off, the lens surfaces are stained with so-called “water spots,” which are traces of water like stains remaining on the lens surfaces, resulting in deteriorated visibility. To prevent the formation of the water spots, the anti-reflection film surfaces are subjected to a water-repelling treatment with curable polysiloxanes, silane compounds having water-repellent groups, etc., so that the anti-reflection films can easily repel water.

Though the above water-repelling treatment to silicon oxide or magnesium fluoride constituting the surface layers of the anti-reflection films can prevent the water spots, it neither makes it difficult for stains such as sweat, sebum, dirt from hands, eye mucus, cosmetics, hairdressings, hair sprays, oils, etc. to attach to the lens surfaces easily, nor makes the stains easily removable from the lens surfaces. Thus, even though the spectacle lenses are used in a usual manner, wiping should be conducted frequently, and the spectacle lenses are likely to be scratched if excess pressure is applied during wiping.

In the above circumstances, JP 2002-148402 A, which is incorporated by reference herein in its entirety, discloses an optical part having an anti-reflection film covered with a layer of ZrO₂, Al₂O₃, Si, etc., the layer being treated with a water- and oil-repellent material such as an aminosilane compound. However, too thin a water- and oil-repellent layer formed on the anti-reflection film fails to exhibit sufficient water- and oil-repellent effects.

JP 2002-121277 A and its counterpart U.S. Pat. No. 6,528,672, which are incorporated by reference herein in their entireties, propose a surface-treating agent comprising perfluoropolyether-modified aminosilane for use in coatings for preventing finger prints and sebum from attaching to optical members such as spectacle lenses. However, because the perfluoropolyether-modified aminosilane is coated on an article in the form of a solution such as in perfluoro-(2-tetrahydrofuran) in JP 2002-121277 A, it is difficult to uniformly form a water- and oil-repellent layer, which is thin to such an extent that the characteristics of the anti-reflection film are not deteriorated.

### OBJECT OF THE INVENTION

Accordingly, an object of the present invention is to provide an anti-reflection spectacle lens having a water- and oil-repellent layer for preventing stains such as sweat, sebum and eye mucus, and oils in cosmetics, etc. from attaching to the lens, and for making it easy to wipe such stains off, without damaging the function of the anti-reflection film.

### SUMMARY OF THE INVENTION

As a result of intense research in view of the above object, the inventor has found that an anti-reflection spectacle lens having both water repellency and oil repellency without losing an anti-reflection function can be obtained by forming a thin and uniform water- and oil-repellent layer on a silicon oxide layer, the outermost layer of an anti-reflection film, and that by conducting the vacuum deposition of the water- and oil-repellent layer in the same vacuum deposition chamber as for the vacuum deposition of the anti-reflection film continuously, the production cost can be reduced. The present invention has been completed based on this finding.

Thus, the anti-reflection spectacle lens of the present invention comprises an anti-reflection film composed of a plurality of layers formed on at least one surface of a lens substrate or other one or more layers formed on said lens substrate, the anti-reflection film comprising an outermost layer made of silicon oxide, and a water- and oil-repellent layer being formed on the silicon oxide layer by vacuum deposition.

The water- and oil-repellent layer preferably has an optical thickness of 10 to 100 nm. The water- and oil-repellent layer is preferably made of an organic compound having in a molecule at least one hydrophobic group and at least one reactive group that can be bonded to a hydroxyl group, more preferably a fluorine-containing organic compound. A preferred example of the fluorine-containing organic compounds is perfluoropolyether-modified aminosilane represented by the following general formula (1):

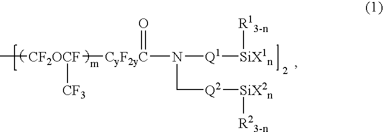

wherein each of X¹ and X² represents a hydrolyzable group, each of R¹ and R² represents a lower alkyl group or a phenyl group, each of Q¹ and Q² represents a bivalent organic group, m represents an integer of 1 to 0.50, n represents 2 or 3, and y represents an integer of 0 to 4.

The anti-reflection film preferably comprises a low-refractive index layer having a refractive index of 1.5 or less and a high-refractive index layer having a refractive index of 2.0 or more. The anti-reflection film preferably has 3 to 7 layers. In any number of layers constituting the anti-reflection film, the outermost layer of the anti-reflection film (i.e., the layer farthest from the lens) should be a low-refractive index layer made of silicon oxide.

The anti-reflection spectacle lens preferably has a hard coat layer formed on the lens substrate, and the above anti-reflection film is preferably formed on the hard coat layer. The above anti-reflection film preferably comprises at least one low-refractive index layer and at least one high-refractive index layer formed alternately.

The method for producing an anti-reflection spectacle lens according to the present invention comprises forming an anti-reflection film composed of a plurality of layers on at least one surface of a lens substrate or other one or more layers formed on said lens substrate by vacuum deposition, the anti-reflection film comprising an outermost layer made of silicon oxide, and then vacuum-depositing an organic compound having in a molecule at least one hydrophobic group and at least one reactive group that can be bonded to a hydroxyl group on the silicon oxide layer continuously in the same vacuum deposition chamber as for the anti-reflection film to form a water- and oil-repellent layer.

In the above method, a porous ceramic pellet or a pellet constituted by a block of metal fibers or thin metal wires, which is impregnated with the organic compound, is preferably placed as an evaporation source in the vacuum deposition chamber. It is further preferable that the porous ceramic pellet impregnated with the organic compound is placed as an evaporation source in the vacuum deposition chamber, and that the pellet is irradiated with electron beams to evaporate the organic compound.

### BRIEF DESCRIPTION OF THE DRAWING

FIG. 1 is a partial cross-sectional view showing an example of the anti-reflection spectacle lens of the present invention.

### DETAILED DESCRIPTION OF THE PREFERRED EMBODIMENTS

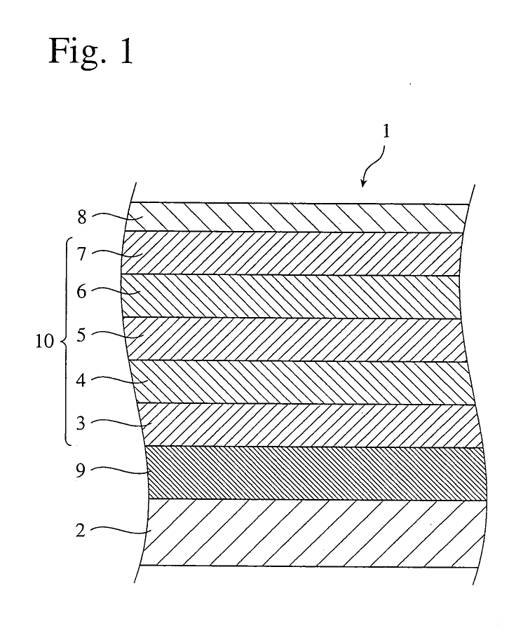

FIG. 1 shows the anti-reflection spectacle lens 1 according to a preferred embodiment of the present invention. This anti-reflection spectacle lens 1 comprises a lens substrate 2, a hard coat layer 9 formed on the lens substrate 2, and a multi-layer anti-reflection film 10 formed on the hard coat layer 9. The anti-reflection film 10 is composed of 5 layers, for instance, which are indicated as layers 3-7.

Though not particularly restrictive, materials for the lens substrate 2 may be colorless or colored, transparent glass or plastic materials, etc. Specific examples of the plastic materials include acrylic resins, polycarbonates, polystyrenes, melamine resins, and polyurethane resins. Though not particularly restrictive, the refractive index of the lens substrate 2 is preferably 1.50 to 1.75. The term “refractive index” used herein means a refractive index at a wavelength of 550 nm. The lens substrate 2 may have a flat or curved surface, on which the anti-reflection film 10 is formed.

The hard coat layer 9 is preferably formed on the lens substrate 2. The hard coat layer 9 can improve physical characteristics of the lens substrate 2 such as surface hardness, and can increase adhesion between the lens substrate 2 and the anti-reflection film 10. The hard coat layer 9 preferably has a thickness of 1 to 10 μm. The refractive index of the hard coat layer 9 is preferably equal to that of the lens substrate 2. When the thickness of the hard coat layer 9 is less than 1 μm, the hard coat layer 9 often fails to exhibit the desired functions. On the other hand, when the thickness of the hard coat layer 9 is more than 10 μm, optical strain may occur in the lens. Before forming the hard coat layer 9, the lens substrate 2 may be subjected to a surface treatment such as corona discharge and high-voltage discharge to increase adhesion to the hard coat layer 9.

Though not particularly restrictive, materials for the hard coat layer 9 may be silicon compounds, polyfunctional acrylics, polyurethanes, melamines, etc. Examples of the silicon compounds include tetraalkoxysilanes, alkyltrialkoxysilanes, and hydrolysates of silane coupling agents having functional groups such as a vinyl group, an allyl group, an epoxy group, and a methacrylic group. Examples of the polyfunctional acrylics include polyol acrylates, polyester acrylates, urethane acrylates, epoxy acrylates, etc. Examples of the polyurethanes include melamine polyurethanes, etc.

It is preferable that the hard coat layer 9 has a refractive index close to those of the spectacle lens 2 and the anti-reflection film 10. In addition, to provide the lens with excellent appearance without interference fringes, the hard coat layer 9 preferably contains fine inorganic particles. The fine inorganic particles may comprise fine oxide particles of at least one metal selected from the group consisting of Si, Sn, Sb, Ce, Zr, and Ti, and composite oxide particles of two or more metals selected from the group consisting of Si, Al, Sn, Sb, Ce, Fe, Zn, Zr, and Ti. Specific examples of the preferred compositions of the fine inorganic particles include SiO₂, SnO₂, Sb₂O₅, CeO₂, ZrO₂, TiO₂, etc. These fine inorganic particles preferably have diameters of 1 to 200 nm. These fine inorganic particles are preferably used in the form of colloidal dispersions in water or organic solvents.

The content of the fine inorganic particles is preferably 45 to 65% by mass based on the entire hard coat layer 9. When the content of the fine inorganic particles is less than 45% by mass, the refractive index of the hard coat layer 9 cannot sufficiently be controlled, failing to prevent interference fringes. On the other hand, when the content of the fine inorganic particles exceeds 65% by mass, the hard coat layer 9 is vulnerable to cracking. Though not particularly restrictive, the methods for forming the hard coat layer 9 may be, for example, various coating methods such as a dip-coating method, a spin-coating method, a spray method, a flow method, etc.

The spectacle lens 2 is provided with an anti-reflection film 10 composed of a plurality of layers 3-7. A plurality of layers constituting the anti-reflection film 10 are preferably laminated such that their refractive indexes alternate like large, small, large, small, . . . By such arrangement of refractive indexes, the anti-reflection film 10 can exhibit sufficient anti-reflection effects with a simple layer structure. Further, the anti-reflection film 10 having such a structure can minimize differences in reflectivity and reflected colors between lights with different incidence angles (e.g. visible lights entering into front and rear surfaces of the spectacle lens) to the spectacle lens 1.

Specifically, to obtain sufficient anti-reflection effects, the anti-reflection film 10 preferably comprises at least one low-refractive index layer having a refractive index of 1.5 or less and at least one high-refractive index layer having a refractive index of 2.0 or more. Though not particularly restrictive, materials for the high-refractive index layer are preferably materials containing ZrO₂ or TiO₂. The optical thickness of each high-refractive index layer is preferably about 50 to 2,000 nm, more preferably about 100 to 1,500 nm. When the optical thickness of the high-refractive index layer is less than 50 nm or more than 2,000 nm, it is difficult to obtain sufficient anti-reflection effects. In a case where the anti-reflection film has a plurality of high-refractive index layers, the materials and optical thickness of the high-refractive index layers may be the same or different.

Though not particularly restrictive, materials for the low-refractive index layer preferably comprise silicon oxide (SiO₂) or magnesium fluoride (MgF₂). The optical thickness of each low-refractive index layer is preferably about 5 to 750 nm, more preferably about 10 to 700 nm. When the optical thickness of each low-refractive index layer is less than 5 nm or more than 750 nm, it is difficult to obtain sufficient anti-reflection effects. In a case where the anti-reflection film has a plurality of low-refractive index layers, the materials and optical thickness of the low-refractive index layers may be the same or different.

The high-refractive index layer and the low-refractive index layer are preferably formed by gas phase film-forming methods such as a vacuum deposition method, a plasma-deposition method, a sputtering method, and an ion-plating method. The vacuum deposition method is particularly preferable in the easiness of controlling a refractive index, an optical thickness, a lamination structure, etc.

The number of layers in the anti-reflection film 10 is preferably 3 to 7. Because the hard coat layer 9 generally has a refractive index close to that of the low-refractive index layer, the anti-reflection film 10 formed on the hard coat layer 9 preferably has a layer structure in the order of a low refractive index, a high refractive index, a low refractive index, . . . In addition, because the outermost layer of the anti-reflection film 10 is a silicon oxide layer (low-refractive index layer) as described below, the total number of layers constituting the anti-reflection film 10 is preferably odd. Accordingly, when the anti-reflection film 10 has less than three layers, it is difficult to sufficiently achieve both anti-reflection and water and oil repellency even if a water- and oil-repellent layer is formed on the anti-reflection film 10. On the other hand, in the case of more than 7 layers, the anti-reflection film 10 is produced by complicated processes, resulting in a high production cost.

In the present invention, the outermost layer of the anti-reflection film 10 is a low-refractive index layer made of silicon oxide, and a water- and oil-repellent layer 8 is formed on the low-refractive index layer. The water- and oil-repellent layer 8 not only functions as a barrier layer for preventing sweat, oils, etc. from penetrating into the anti-reflection film 10 but also functions to prevent the attaching of stains. The words “prevent the attaching of stains” used herein mean not only that stains are not attached to the spectacle lens, but also that stains can easily be wiped off even if they are attached. Namely, the water- and oil-repellent layer 8 maintains water and oil repellency.

The water- and oil-repellent layer 8 formed on the outermost layer of the anti-reflection film 10 should have such a small and uniform thickness as not to have optical influence, so that the anti-reflection characteristics of the anti-reflection film 10 are not deteriorated. Specifically, the optical thickness of the water- and oil-repellent layer 8 is preferably 10 to 100 nm, more preferably 20 to 90 nm. When the optical thickness of the water- and oil-repellent layer 8 is less than 10 nm, water and oil repellency cannot be sufficiently exhibited and maintained. On the other hand, when it exceeds 100 nm, the anti-reflection characteristics of the anti-reflection film 10 are deteriorated.

The water- and oil-repellent layer 8 may be made of an organic compound having in a molecule at least one hydrophobic group and at least one reactive group that can be bonded to a hydroxyl group, which may be called simply “hydrophobic, reactive organic compound.” Preferred as such hydrophobic, reactive organic compounds are fluorine-containing organic compounds having polyfluoroether groups or polyfluoroalkyl groups. A specific example of such fluorine-containing organic compounds is a perfluoropolyether-modified aminosilane represented by the following general formula (1):

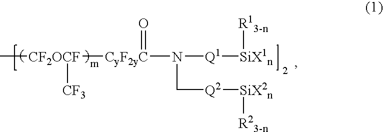

wherein each of X¹ and X² represents a hydrolyzable group, each of R¹ and R² represents a lower alkyl group or a phenyl group, each of Q¹ and Q² represents a bivalent organic group, m represents an integer of 1 to 50, n represents 2 or 3, and y represents an integer of 0 to 4.

In the general formula (1), each of X¹ and X² may be an alkoxy group having 1-10 carbon atoms such as a methoxy group, an ethoxy group, a propoxy group, a butoxy group, etc.; an oxyalkoxy group having 2-10 carbon atoms such as a methoxymethoxy group, methoxyethoxy group, etc.; an acyloxy group having 1-10 carbon atoms such as an acetoxy group, etc.; an alkenyloxy group having 2-10 carbon atoms such as an isopropenoxy group, etc.; a halogen group such as Cl, Br, I, etc. Among them, the methoxy group, the ethoxy group, the isopropenoxy group and the chlorine group are preferable. X¹ and X² may be the same or different.

Each of R¹ and R², which may be the same or different, may be a lower alkyl group having 1-5 carbon atoms, or a phenyl group, which may have an alkyl substituent. Specifically, R¹ and R² may be a methyl group, an ethyl group, a phenyl group, etc., and the methyl group is particularly preferable.

Each of the bivalent organic groups Q¹ and Q² is preferably an alkylene group having 1-10 carbon atoms such as CH₂CH₂CH₂, which may be the same or different.

The number m is an integer of 1 to 50. When m is larger than 50, the percentage of an alkoxysilyl group in the entire fluorine-containing organic compound is extremely small, resulting in poor film-forming properties. From the balance of the water and oil repellency and reactivity, m is preferably in a range of 10-30. The number n representing the number of X¹ and X² is 2 or 3, which may be the same or different.

The compound represented by the general formula (1) is excellent in hydrolyzability and condensation reactivity because of many X¹ and X² (for instance, alkoxy groups) contained in a molecule, and in adhesion to the low-refractive silicon oxide layer. Thus, the water- and oil-repellent layer 8 can be formed with a sufficient thickness on the silicon oxide layer.

Specific examples of the hydrophobic, reactive organic compounds forming the water- and oil-repellent layer 8 are compounds represented by the following formulae (2) to (5).

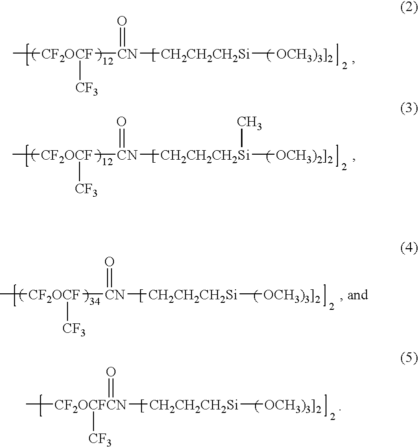

In the present invention, the water- and oil-repellent layer 8 is formed by a vacuum deposition method, so that it is a uniform, thin layer. When the water- and oil-repellent layer 8 is formed by vacuum deposition, an evaporation source of the hydrophobic, reactive organic compound is preferably (a) a porous ceramic impregnated with a hydrophobic, reactive organic compound, or (b) a block of metal fibers or thin metal wires impregnated with a hydrophobic, reactive organic compound, which can quickly absorb and vaporize a large amount of a hydrophobic, reactive organic compound. The porous ceramic is preferably formed into a pellet from the aspect of the easiness of handling.

The metal fibers or thin metal wires may be made of iron, platinum, silver, copper, etc. The metal fibers or the thin metal wires are tangled such that they can retain a sufficient amount of the hydrophobic, reactive organic compound. The metal fibers or the thin metal wires may be woven or nonwoven. The block of metal fibers or thin metal wires may have such a porosity that can be determined depending on how much the hydrophobic, reactive organic compound is retained.

The block of metal fibers or thin metal wires is preferably held in a vessel having an open end. The block of metal fibers or thin metal wires held in the vessel may be called pellet. The vessel is not particularly restricted in its shape and may be selected from a Knudsen-type vessel, a nozzle-type vessel with an expanding end portion, a cylindrical vessel, a cylindrical vessel with an expanding end portion, a boat-type vessel, a filament-type vessel, etc., depending on the specifications of the deposition apparatus. At least one end of the vessel is open, so that the evaporated hydrophobic, reactive organic compound exits from the opening. Materials for the vessel may be metals such as copper, tungsten, tantalum, molybdenum and nickel, ceramics such as alumina, carbon, etc., which may be properly selected depending on the types of the deposition apparatus and the hydrophobic, reactive organic compound.

Any of the porous ceramic pellet, and the pellet constituted by the block of metal fibers or thin metal wires held in the vessel is not restricted in size.

When the porous ceramic or the block of metal fibers or thin metal wires is impregnated with the hydrophobic, reactive organic compound, a solution of the hydrophobic, reactive organic compound in an organic solvent is first prepared, and applied to the porous ceramic or the metal fibers or thin metal wires for impregnation by a dipping method, a dropping method, a spraying method, etc., followed by the evaporation of the organic solvent. Because the hydrophobic, reactive organic compound has a reactive group (hydrolyzable group), it is preferable to use an inert organic solvent.

The inert organic solvents may be fluorine-modified aliphatic hydrocarbon solvents such as perfluoroheptane, perfluorooctane, etc.; fluorine-modified aromatic hydrocarbon solvents such as m-xylene hexafluoride, benzotrifluoride, etc.; fluorine-modified ether solvents such as methyl perfluorobutyl ether, perfluoro(2-butyl tetrahydrofuran), etc.; fluorine-modified alkylamine solvents such as perfluorotributylamine, perfluorotripentylamine, etc.; hydrocarbon solvents such as toluene, xylene, etc.; ketone solvents such as acetone, methyl ethyl ketone, methyl isobutyl ketone, etc. Among them, the fluorine-modified organic solvents are preferable, and particularly m-xylene hexafluoride, perfluoro(2-butyl tetrahydrofuran) and perfluorotributylamine are preferable. These organic solvents may be used alone or in combination. The concentration of the hydrophobic, reactive organic compound in the solution is not restrictive, but may be properly determined depending on the form of the carrier impregnated with the hydrophobic, reactive organic compound.

The evaporation source may be heated by a halogen lamp, a sheath heater, a resister heater, electron beams, plasma electron beams, an induction heater, etc. From the aspect of the easiness of controlling the amount of the hydrophobic, reactive organic compound evaporated, the pellet is preferably irradiated with electron beams. When the pellet constituted by the block of metal fibers or thin metal wires held in the vessel is used, heat generation may be achieved by supplying electric current to the metal fibers or the thin metal wires.

The vacuum deposition is preferably carried out at a vacuum degree of 10⁻⁵ to 10⁻⁶ Torr. If the vacuum degree were higher than 10⁻⁶ Torr or lower than 10⁻⁵ Torr, the vacuum deposition would need a long time, resulting in decreased production efficiency, or cause insufficient vacuum deposition, failing to form a water- and oil-repellent layer. The substrate temperature is preferably 60-120° C. during the vacuum deposition.

The vacuum deposition of the water- and oil-repellent layer is preferably conducted in the same vacuum deposition chamber as for the vacuum deposition of the anti-reflection film continuously. This can be accomplished by changing the evaporation source from silicon oxide for forming the outermost layer of the anti-reflection film to the pellet of the porous ceramic or the block of metal fibers or thin metal wires impregnated with the hydrophobic, reactive organic compound. Because the pellet can be handled as easily as an inorganic evaporation source, it is suitable for conducting vacuum deposition in the same vacuum deposition chamber as for the vacuum deposition of the anti-reflection film continuously.

The present invention will be explained in more detail referring to Examples below without intention of restricting the present invention thereto.

### EXAMPLE 1

(1) Production of Anti-Reflection Spectacle Lens

A silicone resin solution was applied to a spectacle lens substrate 2 made of a polyurethane resin (refractive index: 1.67) by a dipping method and cured to form a 2.8 μm-thick hard coat layer 9 having a refractive index of 1.66. The spectacle lens 2 provided with the hard coat layer 9 was then placed in a vacuum deposition chamber, a five-layer anti-reflection film 10 comprising a low-refractive index layer 3, a high-refractive index layer 4, a low-refractive index layer 5, a high-refractive index layer 6 and a low-refractive index layer 7, and a water- and oil-repellent layer 8 were continuously formed on the hard coat layer 9 by a vacuum deposition method. The coated spectacle lens 2 was taken out from the vacuum deposition chamber and left to stand in the air. A hydrolysis reaction takes place in the water- and oil-repellent layer 8 with moisture in the air, resulting in the curing of the water- and oil-repellent layer 8. Thus, an anti-reflection spectacle lens 1 shown in FIG. 1 was produced. The materials, optical thickness and refractive indexes of each layer of the anti-reflection film 10 and the water- and oil-repellent layer 8, and their vacuum deposition conditions are shown in Table 1, in which Layer No. represents the reference numeral of each layer.

TABLE 1

| | Composition and Properties of Layer | | | Vacuum deposition Conditions | | |
|---|---|---|---|---|---|---|
| | | Optical | | Temperature | Vacuum | |
| Layer | | Thickness | Refractive | of Substrate | Degree | Gas |
| No. | Material | (nm) | Index | (° C.) | (Torr) | Introduced |
| 3 | SiO₂ | 193 | 1.462 | 80 | 1 × 10⁻⁵ | None |
| 4 | TiO₂ | 146 | 2.255 | 80 | 1 × 10⁻⁴ | Oxygen |
| 5 | SiO₂ | 188 | 1.462 | 80 | 1 × 10⁻⁵ | None |
| 6 | TiO₂ | 1072 | 2.255 | 80 | 1 × 10⁻⁵ | Oxygen |
| 7 | SiO₂ | 490 | 1.462 | 80 | 1 × 10⁻⁵ | None |
| 8 | Compound of | 48 | 1.361 | 80 | 1 × 10⁻⁶ | None |
| | Formula (2) | | | | | |

(2) Evaluation

The anti-reflection spectacle lens produced in (1) was evaluated as follows. The results are shown in Table 4.

(a) Abrasion Resistance Test

The lens surface having the hard coat layer 9, the anti-reflection film 10 and the water- and oil-repellent layer 8 was rubbed with a steel wool (#0000) reciprocating 30 times under a load of 1 kg at a stroke of 20 mm and a rate of 2.6 seconds per one reciprocation. Scratches on the lens surface were observed by the naked eye and evaluated by the following criteria.

A: Substantially no scratches were observed.

B: Several scratches were observed.

C: Many scratches were observed.

(b) Scratch Resistance Test

The lens surface having the hard coat layer 9, the anti-reflection film 10 and the water- and oil-repellent layer 8 was rubbed with a commercially available spectacles-wiping cloth reciprocating 1600 times under a load of 0.2 kg at a stroke of 20 mm and a rate of 2.6 seconds per one reciprocation. Scratches on the surface were observed by the naked eye and evaluated by the same criteria as in (a).

(c) Chemical Resistance Test

The lens was soaked in a commercially available neutral detergent for 6 hours to evaluate its appearance by the following criteria.

A: Changes were not observed.

B: Interference color was changed.

C: The water- and oil-repellent layer 8 was dissolved away.

(d) Water Repellency Test

A contact angle between water and the lens surface having the hard coat layer 9, the anti-reflection film 10 and the water- and oil-repellent layer 8 was measured by a contact angle meter CA-W available from Kyowa Interface Science Co., Ltd.

(e) Oil Repellency Test

A 40-mm-long straight line was drawn on the lens surface having the hard coat layer 9, the anti-reflection film 10 and the water- and oil-repellent layer 8, by an organic solvent-type marker having the trade name of McKee Gokuboso available from Zebra Co., Ltd., to evaluate by the naked eye how difficult the organic solvent-type ink was attached to the lens surface. It was further evaluated how easily the attached ink was wiped off by a tissue paper. The evaluation criteria were as follows.

Difficulty in attaching marker

A: The marker was not substantially attached to the lens surface.

B: The marker was slightly attached to the lens surface.

C: The marker was fully attached to the lens surface.

Easiness in wiping marker off

A: The marker was easily wiped off.

B: The marker was hard to wipe off.

C: The marker could not be wipe off.

(f) Anti-Reflection

As a result of evaluating the anti-reflection function of the spectacle lens by the naked eye, it was found that the spectacle lens of this Example was free from reflection like a spectacle lens having no water- and oil-repellent layer 8.

### EXAMPLE 2

An anti-reflection spectacle lens 1 was produced in the same manner as in Example 1 except for changing the material of the water- and oil-repellent layer 8 to the compound represented by the above formula (3). The materials, optical thickness and refractive indexes of each layer of the anti-reflection film 10 and the water- and oil-repellent layer 8, and their vacuum deposition conditions are shown in Table 2, in which Layer No. represents the reference-numeral of each layer. The resultant anti-reflection spectacle lens was evaluated in the same manner as in Example 1. The results are shown in Table 4. This spectacle lens had the same anti-reflection function as that of a spectacle lens having no water- and oil-repellent layer 8.

TABLE 2

| | Composition and Properties of Layer | | | Vacuum Deposition Conditions | | |
|---|---|---|---|---|---|---|
| | | Optical | | Temperature | Vacuum | |
| Layer | | Thickness | Refractive | of Substrate | Degree | Gas |
| No. | Material | (nm) | Index | (° C.) | (Torr) | Introduced |
| 3 | SiO₂ | 193 | 1.462 | 80 | 1 × 10⁻⁵ | None |
| 4 | TiO₂ | 146 | 2.255 | 80 | 1 × 10⁻⁴ | Oxygen |
| 5 | SiO₂ | 188 | 1.462 | 80 | 1 × 10⁻⁵ | None |
| 6 | TiO₂ | 1072 | 2.255 | 80 | 1 × 10⁻⁵ | Oxygen |
| 7 | SiO₂ | 490 | 1.462 | 80 | 1 × 10⁻⁵ | None |
| 8 | Compound of | 48 | 1.361 | 80 | 1 × 10⁻⁶ | None |
| | Formula (3) | | | | | |

### EXAMPLE 3

An anti-reflection spectacle lens 1 was produced in the same manner as in Example 1 except for changing the material of the water- and oil-repellent layer 8 to the compound represented by the above formula (4). The materials, optical thickness and refractive indexes of each layer of the anti-reflection film 10 and the water- and oil-repellent layer 8, and their vacuum deposition conditions are shown in Table 3, in which Layer No. represents the reference numeral of each layer. The resultant anti-reflection spectacle lens was evaluated in the same manner as in Example 1. The results are shown in Table 4. This spectacle lens had the same anti-reflection function as that of a spectacle lens having no water- and oil-repellent layer 8.

TABLE 3

| | Composition and Properties of Layer | | | Vacuum Deposition Conditions | | |
|---|---|---|---|---|---|---|
| | | Optical | | Temperature | Vacuum | |
| Layer | | Thickness | Refractive | of Substrate | Degree | Gas |
| No. | Material | (nm) | Index | (° C.) | (Torr) | Introduced |
| 3 | SiO₂ | 193 | 1.462 | 80 | 1 × 10⁻⁵ | None |
| 4 | TiO₂ | 146 | 2.255 | 80 | 1 × 10⁻⁴ | Oxygen |
| 5 | SiO₂ | 188 | 1.462 | 80 | 1 × 10⁻⁵ | None |
| 6 | TiO₂ | 1072 | 2.255 | 80 | 1 × 10⁻⁵ | Oxygen |
| 7 | SiO₂ | 490 | 1.462 | 80 | 1 × 10⁻⁵ | None |
| 8 | Compound of | 48 | 1.361 | 80 | 1 × 10⁻⁶ | None |
| | Formula (4) | | | | | |

### COMPARATIVE EXAMPLE 1

An anti-reflection spectacle lens was produced in the same manner as in Example 1 except for forming a layer of a water-repellent material OF-110 available from Optron, Inc. (optical thickness: 20 nm) instead of the water- and oil-repellent layer 8. The resultant anti-reflection spectacle lens was evaluated in the same manner as in Example 1. The results are shown in Table 4.

### COMPARATIVE EXAMPLE 2

An anti-reflection spectacle lens was produced in the same manner as in Example 1 except for forming no water- and oil-repellent layer 8. The resultant anti-reflection spectacle lens was evaluated in the same manner as in Example 1. The results are shown in Table 4.

TABLE 4

| | | | | Water | Oil repellency | |
|---|---|---|---|---|---|---|
| | Abrasion | Scratch | Chemical | Repellency | Difficulty in | Easiness in |
| No. | Resistance | Resistance | Resistance | (°) | Attaching | Wiping |
| Example 1 | A | A | A | 108.2 | A | A |
| Example 2 | A | A | A | 107.8 | A | A |
| Example 3 | A | A | A | 108.4 | A | A |
| Com. Ex. 1 | A | B | A | 108.8 | B | C |
| Com. Ex. 2 | B | C | B | 68.4 | C | C |

As described above, because the anti-reflection spectacle lens of the present invention comprises a water- and oil-repellent layer formed by vacuum deposition on the outermost silicon oxide layer of an anti-reflection film, it has excellent water and oil repellency as well as an excellent anti-reflection function. Accordingly, the spectacle lens of the present invention can efficiently prevent aqueous stains and oily stains from attaching thereto, and stains attached to the spectacle lens can easily be wiped off. In addition, because the vacuum deposition of the water- and oil-repellent layer is conducted in the same vacuum deposition chamber as for the vacuum deposition of the anti-reflection film continuously, the production cost of the anti-reflection spectacle lens can be reduced.

Although the present invention has been described with reference to particular means, materials and embodiments, it is to be understood that the present invention is not limited to the particular disclosures but extends to all equivalents within the scope of the claims.

The present disclosure relates to subject matter contained in Japanese Patent Application No. 2002-322506 (filed on Nov. 6, 2002), which is expressly incorporated herein by reference in its entirety.

What is claimed is:

1. An anti-reflection spectacle lens comprising an anti-reflection film composed of a plurality of layers formed on at least one surface of a lens substrate or other one or more layers formed on said lens substrate, wherein said anti-reflection film comprises an outermost layer made of silicon oxide, and a water- and oil-repellent layer is formed on said silicon oxide layer by vacuum deposition.

2. The anti-reflection spectacle lens according to claim 1, wherein said water- and oil-repellent layer has an optical thickness of 10 to 100 nm.

3. The anti-reflection spectacle lens according to claim 1, wherein said water- and oil-repellent layer is made of an organic compound having in a molecule at least one hydrophobic group and at least one reactive group that can be bonded to a hydroxyl group.

4. The anti-reflection spectacle lens according to claim 3, wherein said organic compound is a fluorine-containing organic compound.

5. The anti-reflection spectacle lens according to claim 4, wherein said fluorine-containing organic compound is a perfluoropolyether-modified aminosilane represented by the following general formula (1): 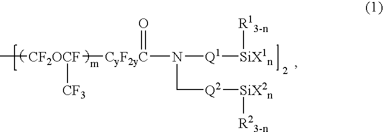
wherein each of X¹ and X² represents a hydrolyzable group, each of R¹ and R² represents a lower alkyl group or a phenyl group, each of Q¹ and Q² represents a bivalent organic group, m represents an integer of 1 to 50, n represents 2 or 3, and y represents an integer of 0 to 4.

6. The anti-reflection spectacle lens according to claim 1, wherein said anti-reflection film comprises at least one low-refractive index layer having a refractive index of 1.5 or less and at least one high-refractive index layer having a refractive index of 2.0 or more.

7. The anti-reflection spectacle lens according to claim 1, wherein said anti-reflection film comprises 3 to 7 layers.

8. The anti-reflection spectacle lens according to claim 1, wherein said other layer is a hard coat layer, and wherein said anti-reflection film is formed on said hard coat layer.

9. The anti-reflection spectacle lens according to claim 6, wherein said anti-reflection film is constituted by said at least one low-refractive index layer and said at least one high-refractive index layer alternately.

10. The anti-reflection spectacle lens according to claim 1, wherein said outermost layer is a low-refractive index layer.

11. A method for producing an anti-reflection spectacle lens comprising forming an anti-reflection film composed of a plurality of layers on at least one surface of a lens substrate or other one or more layers formed on said lens substrate by vacuum deposition, said anti-reflection film comprising an outermost layer made of silicon oxide, and then vacuum-depositing an organic compound having in a molecule at least one hydrophobic group and at least one reactive group that can be bonded to a hydroxyl group on said silicon oxide layer continuously in the same vacuum deposition chamber as for said anti-reflection film to form a water- and oil-repellent layer.

12. The method according to claim 11, wherein said water- and oil-repellent layer has an optical thickness of 10 to 100 nm.

13. The method according to claim 11, wherein said organic compound is a fluorine-containing organic compound.

14. The method according to claim 13, wherein said fluorine-containing organic compound is a perfluoropolyether-modified aminosilane represented by the following general formula (1): 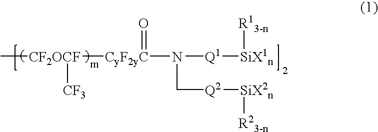
wherein each of X¹ and X² represents a hydrolyzable group, each of R¹ and R² represents a lower alkyl group or a phenyl group, each of Q¹ and Q² represents a bivalent organic group, m represents an integer of 1 to 50, n represents 2 or 3, and y represents an integer of 0 to 4.

15. The method according to claim 11, wherein a porous ceramic pellet or a pellet constituted by a block of metal fibers or thin metal wires, which is impregnated with said organic compound, is placed as an evaporation source in said vacuum deposition chamber.

16. The method according to claim 15, wherein a porous ceramic pellet impregnated with said organic compound is placed as an evaporation source in said vacuum deposition chamber, and wherein said pellet is irradiated with electron beams to evaporate said organic compound.
